(19) United States
(12) Patent Application Publication
(10) Pub. No.: US 2026/0086484 A1
(43) Pub. Date: Mar. 26, 2026

(54) IMAGE FORMING APPARATUS

(71) Applicant: CANON KABUSHIKI KAISHA, Tokyo (JP)

(72) Inventor: TOSHIYA KAINO, Shizuoka (JP)

(21) Appl. No.: 19/331,896

(22) Filed: Sep. 17, 2025

(30) Foreign Application Priority Data
Sep. 25, 2024 (JP) 2024-166046

(51) Int. Cl. G03G 15/00; G03G 15/20

(52) U.S. Cl. CPC G03G 15/553; G03G 15/2039; G03G 15/2064; G03G 2215/2025; G03G 2215/2051

(57) ABSTRACT

An image forming apparatus includes a temperature-rise counter that increases a count when a temperature of a sheet non-passing portion of a pressing roller exceeds a threshold temperature and a lifespan counter different from the temperature-rise counter, where determining an end of a lifespan of a fixing unit is based on a count value that increases the most between a count value of the temperature-rise counter and a count value of the lifespan counter different from the temperature-rise counter.

### BACKGROUND

### Field of the Technology

The present disclosure relates to an image forming apparatus, such as a printer using an electrophotographic system or an electrostatic recording system, or a copying machine.

### Description of the Related Art

A fixing device that fixes a toner image T formed on a recording medium to the recording medium is mounted in an electrophotographic image forming apparatus. There are various types of fixing devices. A film-heating fixing device in which a plate-shaped heater is disposed in a fixing film, serving as a fixing rotating body, and in which a fixing nip portion where the heater and a pressing roller nip the fixing film is formed is one of such various types of fixing devices.

There is a problem in that, when the toner image T formed on a small-sized recording medium with a small width is fixed, there occurs a sheet-non-passing-portion temperature-rise in which the temperature of a sheet-non-passing region of the fixing device, where the recording medium does not pass in a longitudinal direction of the fixing device, rises excessively. While this sheet-non-passing-portion temperature-rise becomes a problem regardless of the type of fixing device, this problem becomes noticeable in a fixing device with a small heat capacity, as in the film-heating fixing device. When the sheet-non-passing-portion temperature-rise occurs, in the case of the film-heating fixing device, members, such as the fixing film and the pressing roller, are exposed to high temperatures and are damaged. For example, when the fixing film rotates at high temperatures, a surface layer of the fixing film wears due to a friction force between the fixing film and the pressing roller. When the surface layer wears, an image defect occurs.

Japanese Patent Laid-Open No. 2018-97172 is seen to discuss that a surface-layer wear amount according to a fixing-device operating condition is predicted for each division region of a fixing film in a longitudinal direction, the end of a lifespan of the fixing film is determined, and a notification of the end of the lifespan of the fixing device is provided.

In many cases, sheets are generally used at, for example, existing offices by primarily using sheets with a maximum width that can be passed (for example, A4-size sheets when an A4 device is used, or A3-size sheets or A4-size horizontal sheets when an A3 device is used), and by, depending upon circumstances, using sheets with a width that is smaller than the width of sheets with the maximum width that can be passed. When sheets are generally used in this way, it is possible to suppress occurrence of an image defect by the lifespan control method that is seen to be discussed in Japanese Patent Laid-Open No. 2018-97172.

In particular sectors, that is, in a vertical market, there is a case in which particular small-sized sheets with a width that is smaller than the maximum width that can be passed are used as sheets with a main sheet size, and the particular small-sized sheets are used so as to be continuously fed in large numbers. When sheets are used in such a way, the lifespan prediction method that is seen to be discussed in Japanese Patent Laid-Open No. 2018-97172 may not necessarily determine the end of a lifespan of a fixing device.

When the temperature of a sheet non-passing portion of a pressing roller rises due to feeding of a large number of small-sized sheets, a rubber layer of the pressing roller at this region thermally expands, and the outside diameter thereof increases. While a surface layer of the pressing roller is covered with fluororesin with releasability for preventing soiling by toner, the surface layer (fluororesin tube) is also expanded by the thermal expansion of the rubber layer. When the temperature rise of the sheet non-passing portion is relatively low or when the temperature rise is high but only for a short time, the surface-layer tube also contracts as the rubber contracts at the time of cooling. When small-sized sheets are continuously fed in large numbers, the temperature rise of the sheet non-passing portion of the pressing roller is kept in a high state for a long time. Therefore, the surface-layer tube gradually undergoes plastic deformation and is stretched out.

When the surface-layer tube is stretched out, even if, at the time of cooling, the shape of the rubber layer returns to its original external shape, since the shape of the surface layer cannot return to its original shape, the tube becomes wrinkled. When small-sized sheets are repeatedly continuously fed in large numbers, the wrinkling of the tube becomes serious, and, when, in this state, sheets with the maximum width that can be passed are continuously fed, a conveyance force at a roller end portion where the tube is wrinkled is decreased, and thus the sheets may also become wrinkled.

While the timing at which the wrinkling of the sheets caused by the wrinkling of the tube occurs differs depending upon the way the small-sized sheets are fed, when the sheets are repeatedly continuously fed in large numbers, the end of a lifespan of the pressing roller is reached before the end of a lifespan of a fixing film, resulting in the sheets becoming wrinkled.

The issue regarding the precision of determination of the end of the lifespan of the fixing device is not limited to film-heating fixing devices.

### SUMMARY

The present disclosure is directed to providing an image forming apparatus that determines the end of a lifespan of a fixing device with high precision.

According to an aspect of the present disclosure, an image forming apparatus includes an image forming unit that forms an image on a recording medium, a fixing unit that fixes the image to the recording medium on which the image is formed while the recording medium is nipped and conveyed at a fixing nip portion, the fixing unit including a fixing rotating body and a pressing roller that contacts an outer peripheral surface of the fixing rotating body and forms the fixing nip portion between the pressing roller and the fixing rotating body, the pressing roller including a rubber layer and a fluororesin surface tube layer, at least one memory storing a program, at least one processor, that when executing the program, is caused to determine an end of a lifespan of the fixing unit and provide notification to replace the fixing unit based on a result of the determination, a temperature-rise counter that increases a count when a temperature of a sheet non-passing portion of the pressing roller exceeds a threshold temperature, the temperature of the sheet non-passing portion being a temperature when an image is formed on a recording medium with a width in an axial direction of the pressing roller that is smaller than a maximum width that is usable in the image forming apparatus, and a lifespan counter different from the temperature-rise counter, wherein determining the end of the lifespan of the fixing unit is based on a count value that increases the most between a count value of the temperature-rise counter and a count value of the lifespan counter different from the temperature-rise counter.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of an image forming apparatus.

FIGS. 2A to 2C are schematic sectional views illustrating a structure of a fixing device and a heater.

FIG. 3 is a block diagram illustrating a relationship between a lifespan counter, a determining unit, and a notifying unit.

FIG. 4 is a schematic view illustrating a disposition of a temperature detecting sensor of the fixing device.

FIG. 5 is a flowchart of a notification of the end of a lifespan in a first embodiment.

FIG. 6 is a view of a counter start timing of a temperature-rise counter of the first embodiment.

FIG. 7 is a table illustrating study results of the first embodiment and a comparative example.

FIG. 8 is a schematic view illustrating a disposition of an end-portion thermistor of a second embodiment.

FIG. 9 is a table illustrating a relationship between sheet size and threshold temperature in the second embodiment.

FIG. 10 is a view of a counter start timing of a temperature-rise counter of the second embodiment.

FIG. 11 is a flowchart of a notification of the end of a lifespan in the second embodiment.

### DESCRIPTION OF THE EMBODIMENTS

Modes for carrying out the present disclosure are described, with reference to the drawings, in detail below by way of examples on the basis of embodiments. Dimensions, materials, shapes, and relative dispositions of structural components, etc., that are described in the embodiments can be changed as appropriate depending upon structures or various conditions of an apparatus to which the disclosure is applied. That is, the scope of the present disclosure is not limited to the below embodiments.

### First Embodiment

### Description of Image Forming Apparatus

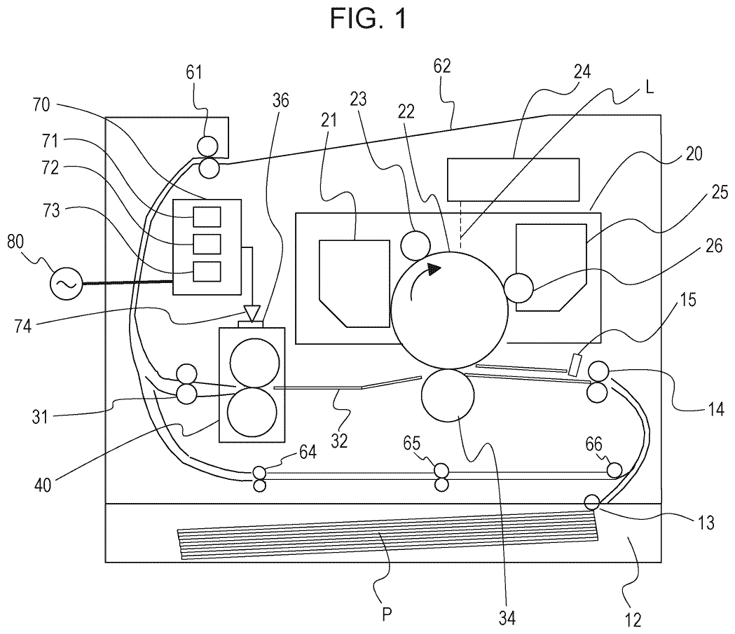

FIG. 1 is a schematic view of an electrophotographic monochrome printer according to a first embodiment. The printer of the present embodiment is a printer that can use A3-size sheets.

An image forming unit 20 includes a photoconductor drum 22 that rotates in the direction of an arrow, a charging roller 23, a developing device 25 that includes a developing roller 26, and a cleaner 21. The photoconductor drum 22 charged by the charging roller 23 is scanned with laser light L corresponding to image information that is output from a laser scanner 24. This causes an electrostatic latent image corresponding to the image information to be formed on the photoconductor drum 22. The electrostatic latent image is developed by toner in the developing device 25. Reference numeral 26 denotes the developing roller. A toner image T formed on the photoconductor drum 22 is transferred to a recording medium P by a transfer roller 34 to which a voltage is applied. These members that form the toner image T onto the recording medium P are collectively called the image forming unit 20. Residual toner on the photoconductor drum 22 is removed from the photoconductor drum 22 by the cleaner 21.

The recording medium P to which the toner image T has been transferred is heated by a fixing device (fixing unit) 40, and the toner image T is fixed to the recording medium P. It should be noted that recording media P stored in a sheet feed tray 12 are fed by a sheet feeding roller 13, reach a registration roller pair 14, and are detected by a registration sensor 15. Then, the recording media P are each conveyed based on a timing at which the toner image T on the photoconductor drum 22 reaches the transfer roller 34. After each recording medium P passes through a transfer nip portion formed by the photoconductor drum 22 and the transfer roller 34, each recording medium P is conveyed to the fixing device 40 along a conveyance guide 32. Each recording medium P that has passed through the fixing device 40 is discharged to a discharge tray 62 by conveying rollers 31 and discharge rollers 61.

For double-sided printing, a recording medium P to which fixing has been performed at the fixing device 40 is conveyed to the discharge rollers 61 by the conveying rollers 31. Then, based on switching the direction of rotation of each discharge roller 61 to the opposite direction, the recording medium P is conveyed toward double-sided rollers 64 and double-sided rollers 65 in a double-sided conveying path. The recording medium P is conveyed from the double-sided rollers 64 and the double-sided rollers 65 to a double-sided re-feeding roller 66, and reaches the registration roller pair 14 again. Then, a step that is the same as that of single-sided printing is performed on the recording medium P, and the recording medium P is discharged onto the discharge tray 62.

A controller 70 includes a CPU 71, ROM 72, and RAM 73. The CPU 71 executes various programs stored in the ROM 72, and, while using the RAM 73 as a working space, controls various operations related to image formation. The ROM 72 and the RAM 73 are examples of storing units that store information used in controlling the image forming apparatus. The ROM 72 is an example of a non-transitory storage medium that stores control programs of the image forming apparatus.

### Structure of Fixing Device

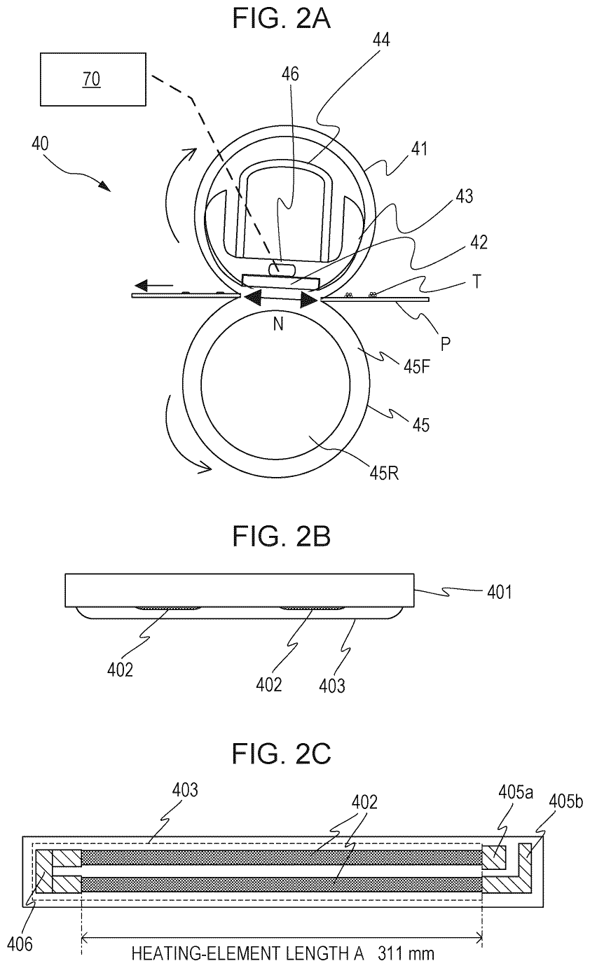

FIG. 2A is a schematic view of the fixing device 40, and FIGS. 2B and 2C are each views of a heater of the fixing device 40. The fixing device 40 is where, while a recording medium P on which a toner image T has been formed is nipped and conveyed at a fixing nip portion N, the toner image T is fixed to the recording medium. The fixing device 40 includes a cylindrical fixing film (fixing belt) 41, which is a fixing rotating body, and a heater 42 that is disposed in an internal space of the fixing film 41 and that contacts the fixing film 41. A heat-resistant resin holding member 43 that holds the heater 42 and guides the rotation of the fixing film 41, and a metal stay 44 that reinforces the holding member 43 are also provided in the internal space of the fixing film 41. The fixing device 40 includes a pressing roller 45 that contacts an outer peripheral surface of the fixing film 41 and forms the fixing nip portion N between it and the fixing film 41.

The pressure of a pressurizing spring (not shown) for forming the fixing nip portion N is applied to the stay 44 toward the pressing roller 45. The total pressure of the pressurizing spring is 250 N, and the width of the fixing nip portion N in a recording medium conveying direction is set at 9.0 mm. A drive gear (not shown) is attached to an end portion of the pressing roller 45, and the pressing roller 45 receives motive power from a motor (not shown) and rotates. Rotation of the pressing roller 45 results in driving and rotating the fixing film 41. A recording medium P that bears a toner image T is heated and fixed while being nipped and conveyed in a direction of an arrow at the fixing nip portion N.

The outside diameter of the fixing film 41 of the present embodiment is 24 mm. The fixing film 41 includes a base layer with a thickness of 70 μm and is made of polyimide resin, a silicone rubber layer provided on an outer side of the base layer with a thickness of 300 μm, and a PFA tube layer serving as a surface layer with a thickness of 20 μm. In the present embodiment the silicone rubber layer is provided as an example of the fixing film 41 for enhancing fixing ability. In a case where there is no issue in the fixing ability, the rubber layer need not be provided. The outside diameter of the pressing roller 45 is 25 mm. The pressing roller 45 includes a metal core with an outside diameter of 17 mm, a silicone rubber layer (rubber layer) 45R having a thickness of 4 mm, and a fluororesin tube layer (surface tube layer) 45F, specifically, a PFA tube layer, with a thickness of 40 μm.

The structure of the heater 42 is described using FIGS. 2B and 2C. FIG. 2B is a sectional view of the heater 42. A substrate 401 of the heater 42 is made of ceramic (alumina) with a thickness of 1.0 mm. The length of the substrate 401 in a longitudinal direction is 370 mm and the length of the substrate 401 in a transverse direction (conveying direction of a recording medium P) is 8.0 mm. A resistive heating element 402 with a thickness of 10 μm and a protective glass layer 403 with a thickness of 60 μm are provided on a side of a surface of the heater 42 that contacts the fixing film 41. The resistive heating element 402 is formed by coating the substrate 401 with a conductive paste including a silver-palladium (Ag/Pd) alloy as a result of screen printing, and then by performing calcination.

Fluorine grease is applied to a portion between the protective glass layer 403 and the fixing film 41, and a good sliding ability of the fixing film 41 is ensured. FIG. 2C is a schematic view of the heater when viewed from a side of a surface of the heater. The resistive heating element 402 is formed in the shape of a belt along a longitudinal direction of the heater.

The protective glass layer 403 (region surrounded by a dotted line) covers the resistive heating element 402 and a conductive portion 406 to ensure insulating properties. A length A of the resistive heating element 402 is 311 mm and the resistance value of the resistive heating element 402 is 9.0 Ω. While, in the present embodiment, the substrate 401 of the heater 42 is indicated as being made of ceramic, the substrate 401 may be made of a metal, where the metal substrate needs to be covered with an insulating layer. While the resistive heating element 402 has a belt shape in which end portions thereof in the longitudinal direction of the heater are folded back, a heater in which a plurality of resistive heating elements with different resistance value distributions are disposed side by side in a transverse direction of the heater and in which electric power can be independently supplied to each of the resistive heating elements 402 can be used.

A thermistor 46, which is a temperature detection element, is disposed on a back surface of the heater 42, and detects the temperature of the heater 42. The thermistor 46 is provided at a central portion of the heater 42 in the longitudinal direction of the heater 42.

The resistive heating element 402 of the heater 42 generates heat by electric power that is supplied from an alternating-current power supply 80 via electrodes 405a and 405b. A bi-directional thyristor (switching element) (not shown) is provided in a power supply path for supplying electric power from the alternating-current power supply 80 to the heater 42. The controller 70 controls the bi-directional thyristor based on the detection temperature of the thermistor 46. This enables controlling the heat generation of the heater 42.

### Control of End of Lifespan of Fixing Device

A lifespan counter LC that controls the end of the lifespan of the fixing device 40 includes a temperature-rise counter C2 and a lifespan counter LC different from the temperature-rise counter C2. The temperature-rise counter C2 is a counter that increases a count when the temperature of a sheet non-passing portion of the pressing roller 45 exceeds a threshold temperature. The temperature of the sheet non-passing portion is a temperature when an image is formed on a recording medium P with a width in an axial direction of the pressing roller 45 that is smaller than a maximum width that can be used in the image forming apparatus. In the present embodiment, a number-of-sheets counter C1 that counts the number of recording media P (sheets) that pass the fixing nip portion N corresponds to the lifespan counter LC different from the temperature-rise counter C2. A determining unit HA determines the end of the lifespan of the fixing device 40 based on the count value between a count value of the temperature-rise counter C2 and a count value of the lifespan counter LC different from the temperature-rise counter C2 (the number-of-sheets counter C1) that increases the most.

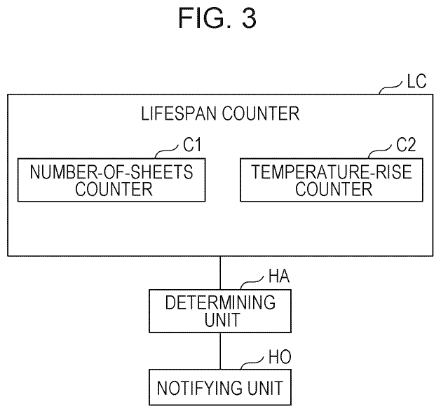

FIG. 3 illustrates two counters that, as described above, are used to determine the end of the lifespan of the fixing device 40 at the determining unit HA. The first lifespan counter LC is the number-of-sheets counter C1 that counts the number of recording media P that pass through the fixing nip portion N. When the count value reaches 150,000 sheets (threshold value) when converted to A4-size horizontal sheets, it is determined that the end of the lifespan of the fixing device 40 is reached. The number of A3-size sheets (420 mm) is two when converted to A4-size horizontal sheets, and the number of A5-size horizontal sheets (148 mm) is 0.7 when converted to A4-size horizontal sheets. “Converted to A4-size horizontal sheets” refers to a method in which an A4-size horizontal recording medium P having a length of 210 mm in a conveying direction is counted as one sheet.

The surface layer 41 of the fixing film 41 is scraped due to wearing of a recording medium P. When the amount of wearing exceeds a certain level, the releasability is decreased, and thus an image defect like an offset image occurs. The number-of-sheets counter C1 is used in predicting the amount of wearing of the surface layer of the fixing film 41 caused by the recording medium P.

The second lifespan counter LC is the temperature-rise counter C2 that controls a thermal history of a temperature rise of the sheet non-passing portion of the pressing roller 45, where the temperature rise occurs when a recording medium P with a width that is smaller than the width of a recording medium P with a maximum size that can be conveyed is conveyed. The temperature-rise counter C2 counts the time during which the temperature of the sheet non-passing portion of the pressing roller 45 exceeds the threshold temperature.

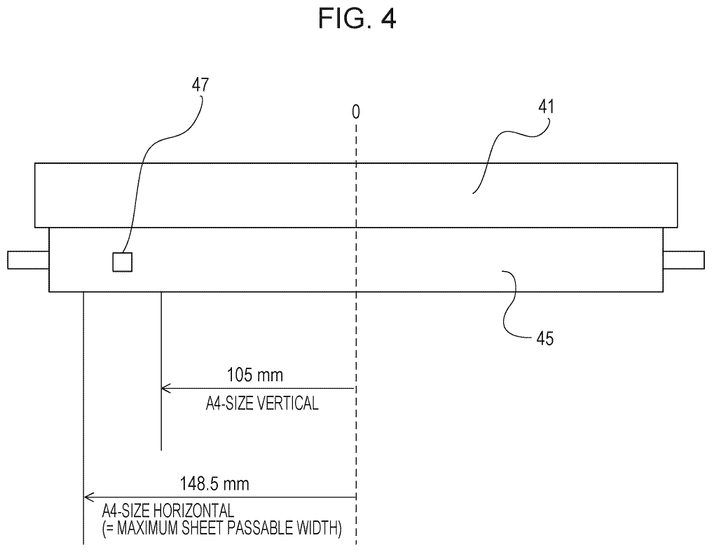

FIG. 4 illustrates the disposition of a temperature detecting sensor 47 that detects the temperature of the sheet non-passing portion of the pressing roller 45. Since the temperature detecting sensor 47 measures the temperature rise of the sheet non-passing portion of the pressing roller 45, the temperature detecting sensor 47 is disposed inward of a position at 148.5 mm, which is the position of a sheet edge of an A4-size horizontal sheet with a maximum width that can be passed and outward of a position at 105 mm, which is the position of a sheet edge of an A4-size vertical sheet.

When the temperature detecting sensor 47 is disposed at such a position, the temperature detecting sensor 47 can measure the temperature rise of the sheet non-passing portion for various sheet sizes. The temperature detecting sensor 47 and the temperature-rise counter C2 count a cumulative time of the state in which the threshold temperature is exceeded. When 45 hours, which is a reference time (threshold value), is reached, it is determined that the end of the lifespan of the fixing device 40 is reached, and a notifying unit HO provides a notification to replace the fixing device 40.

In the present embodiment, the two lifespan counters LC (C1, C2) above are provided, and, when either of the count values reaches the threshold value, it is determined that the end of the lifespan of the fixing device 40 is reached, and a notification is provided that the end of the lifespan of the fixing device 40 is reached and the fixing device 40 needs to be replaced. Of the two counter values, the counter value that is larger may be used to indicate the amount of use (maximum 100%) of the fixing device 40.

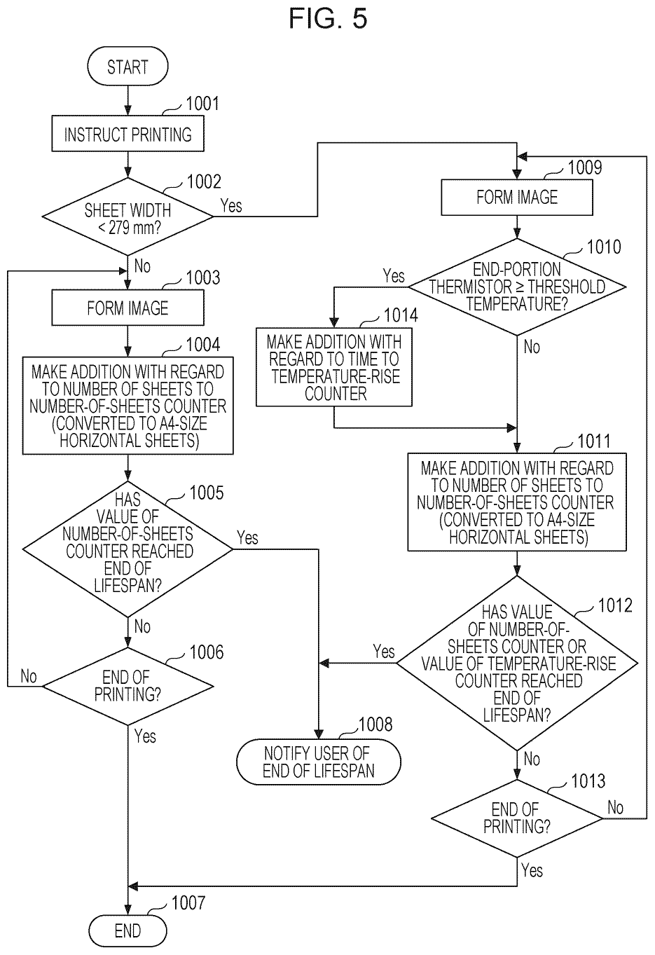

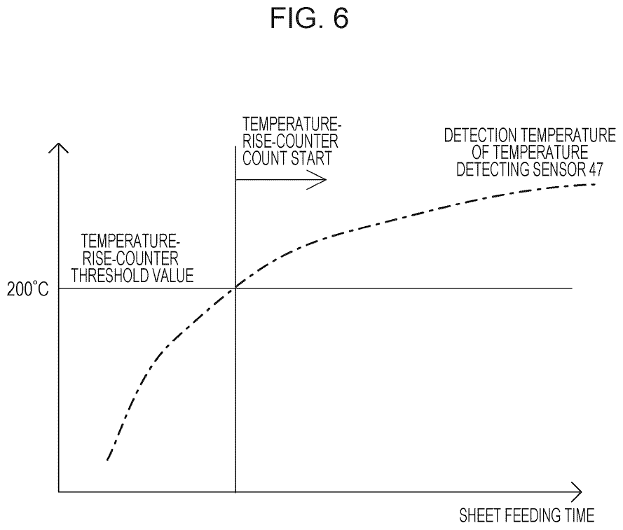

FIG. 5 and FIG. 6 illustrate notifying a user of the end of a lifespan. FIG. 5 is a flowchart of a notification of the end of a lifespan at the time of printing, while FIG. 6 illustrates a detection temperature detected by the temperature detecting sensor 47 and a count start timing of the temperature-rise counter C2.

When a user provides a printing instruction (1001), it is determined whether a sheet width is less than 279 mm from print information (1002). When the sheet width is greater than or equal to 279 mm, an addition with regard to the number of sheets converted to A4-size horizontal sheets is made to the number-of-sheets counter C1 from sheet size information for each image formation (1003, 1004). When the number of sheets of the number-of-sheets counter C1 reaches 150,000 (1005), the printing is suspended and a notification is provided to the user that the end of the lifespan of the fixing device 40 has been reached (1008). When the number of sheets of the number-of-sheets counter C1 has not reached 150,000 (1005), a determination is made whether to end printing (1006). If it is determined not to end the printing, then 1003 to 1006 are repeated until the printing ends. If it is determined that printing has ended (1006), the flowchart of FIG. 5 ends (1007).

When the sheet width is less than 279 mm from the sheet size information of a print signal (1002), after image formation is started (1009), a comparison is made whether the temperature that is measured by the temperature detecting sensor 47 is greater than or equal to the threshold temperature that is 200° C. (1010). When the temperature of the sheet non-passing portion is less than the threshold temperature that is 200° C., a numeral value of the temperature-rise counter C2 is not increased, and an addition with regard to the number of sheets converted to A4-size horizontal sheets is made to the number-of-sheets counter C1 from the sheet size information (1011). When the temperature of the sheet non-passing portion is greater than or equal to the threshold temperature that is 200° C. (1010), the temperature-rise counter C2 increases the cumulative time of the state in which the detection temperature detected by the temperature detecting sensor 47 is greater than or equal to 200° C. (1014), as illustrated in FIG. 6.

When the number of sheets of the number-of-sheets counter C1 exceeds 150,000 or when the cumulative time of the temperature-rise counter C2 exceeds 45 hours (1012), a notification is provided to the user that the end of the lifespan has been reached (1008). When the number of sheets of the number-of-sheets counter C1 has not exceeded 150,000 or when the cumulative time of the temperature-rise counter C2 has not exceeded 45 hours, a determination is made whether to end the printing (1013). If it is determined to end the printing, the flowchart of FIG. 5 ends (1007). If it is determined not to end the printing, the flow returns to 1009.

To confirm the effects of the present embodiment, the following experiments were carried out. The printing speeds of an image forming apparatus used in the experiments were 36 ppm when printing using A4-size horizontal sheets and 20 ppm when printing using A5-size vertical sheets. For recording media P, CS-068 (68 g/m²) made by CANON KABUSHIKI KAISHA was used as an A4-size sheet, and PB-PAPER (64 g/m²) made by CANON KABUSHIKI KAISHA was used as an A5-size sheet. Durability experiments were performed under the following four sheet feeding conditions until a notification of the end of a lifespan was made:
Sheet Feeding Condition 1: continuous sheet feeding of A4-size horizontal sheets.
Sheet Feeding Condition 2: continuous sheet feeding of A5-size vertical sheets.
Sheet Feeding Condition 3: 500 A5-size vertical sheets and 500 A4-size horizontal sheets were alternately repeatedly fed with a 2-hour suspension of feeding therebetween. That is, feeding of 500 A5-size vertical sheets→2-hour suspension of feeding→feeding of 500 A4-size horizontal sheets→2-hour suspension of feeding→feeding of 500 A5-size vertical sheets→two-hour suspension of feeding→. . .
Sheet Feeding Condition 4: the number of A5-size vertical sheets that were fed and the number of A4-size horizontal sheets that were fed in Sheet Feeding Condition 3 were decreased from 500 to 50, and the suspension time of feeding decreased from two hours to one hour.

Under the above-described four sheet feeding conditions, for each feeding of 10,000 sheets and after a notification of the end of a lifespan, it was confirmed whether a defect occurred when printing was been performed on A3-size sheets of CS-068 (68 g/m²) made by CANON KABUSHIKI KAISHA.

As a comparative example, the image forming apparatus was compared to an image forming apparatus in which only a number-of-sheets counter C1 was provided as a counter for determining the end of a lifespan. The other conditions were the same as those of the image forming apparatus of the present embodiment.

In the number-of-sheets counter C1, since conversion is made to A4-size horizontal sheets, a length of 210 mm in the conveying direction is counted as one sheet. Since the length of an A4-size horizontal sheet in the conveying direction and the length of an A5-size vertical sheet in the conveying direction are 210 mm, both sheets are each counted as one sheet in one sheet feeding.

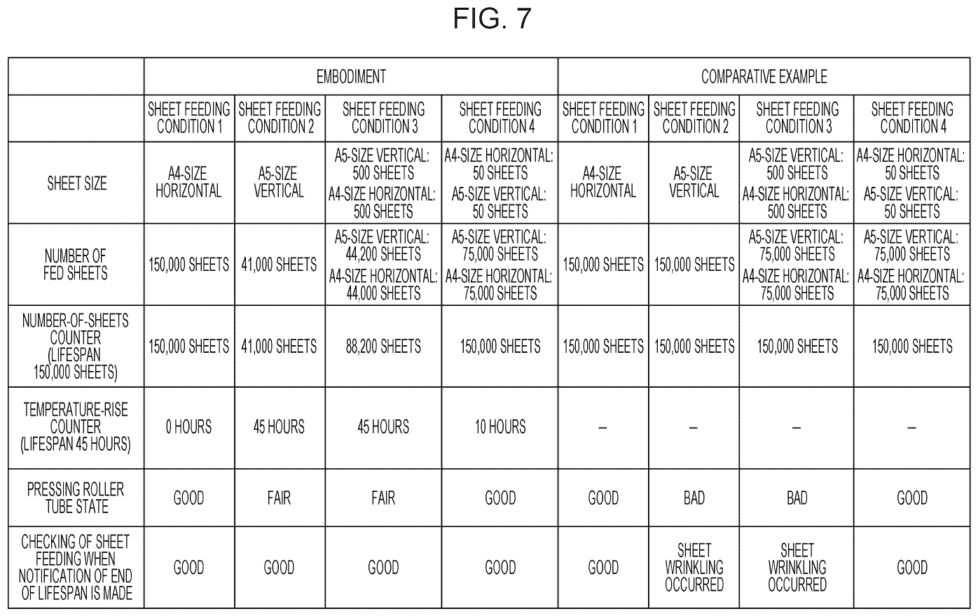

FIG. 7 is a table illustrating study results of the present embodiment and the comparative example. In sheet feeding condition 1 of the present embodiment, since A4-size horizontal sheets are continuously fed, the temperature-rise counter C2 does not operate and a notification of the end of a lifespan is made when the number of sheets of the number-of-sheets counter C1 reaches 150,000. For the A4-size horizontal sheets, since a temperature rise of the sheet non-passing portion almost never occurred, the tube of the pressing roller 45 was almost never wrinkled, and no issues occurred even when A3-size sheets were fed after the notification of the end of the lifespan.

In sheet feeding condition 2, since A5-size vertical sheets are continuously fed, when approximately 42 sheets are fed, the temperature rise of the sheet non-passing portion of the pressing roller 45 reaches 200° C. When the temperature detecting sensor 47 detects 200° C. or higher, the cumulative time at the temperature-rise counter C2 is increased. When the cumulative time at the temperature-rise counter C2 reaches 45 hours corresponding to the end of the lifespan, a notification of the end of the lifespan is provided. At this time, the number of A5-size vertical sheets that were fed was 41,000, and was also 41,000 at the number-of-sheets counter C1. While the tube of the pressing roller 45 at the time of the notification of the end of the lifespan was wrinkled to a certain extent, no issues were present when the feeding of A3-size sheets was checked.

In sheet feeding condition 3, since 500 A4-size horizontal sheets and 500 A5-size vertical sheets are alternately fed with a 2-hour suspension of feeding therebetween, the sheet feeding is started from the time the temperature of the fixing device 40 is substantially room temperature. When the sheet feeding is started from room temperature, the temperature of the sheet non-passing portion of the pressing roller 45 exceeds 200° C. at the time approximately 42 A5-size vertical sheets are fed, and the temperature-rise counter C2 operates at 458 sheets in a sheet feeding of 500 sheets. In the sheet feeding of A4-size horizontal sheets, only the number-of-sheets counter C1 counts. In the sheet feeding of A5-size vertical sheets, only the number-of-sheets counter C1 increases its count for the initial 42 sheets, and the number-of-sheets counter C1 and the temperature-rise counter C2 increase their counts for the remaining 458 sheets.

When the count of the temperature-rise counter C2 reaches 45 hours corresponding to the end of the lifespan, the count of the number-of-sheets counter C1 is 88,200. While the tube of the pressing roller 45 after the notification of the end of the lifespan was wrinkled to a certain extent, it was confirmed that no issues were present when the feeding of A3-size sheets was checked.

In sheet feeding condition 4, A4-size horizontal sheets and A5-size vertical sheets are alternately fed with a 1-hour suspension of feeding therebetween. Since there is a 1-hour suspension of feeding after the feeding of 50 A4-size horizontal sheets and after the feeding of 50 A5-size vertical sheets, the next sheet feeding is started from the time the temperature of the fixing device 40 is substantially room temperature. When the sheet feeding is started from room temperature, the temperature of the sheet non-passing portion of the pressing roller 45 exceeds 200° C. at the time approximately 42 A5-size vertical sheets are fed, and the temperature-rise counter C2 operates at 8 sheets in a sheet feeding of 50 sheets. In the sheet feeding of A4-size horizontal sheets, only the number-of-sheets counter C1 counts. In the sheet feeding of A5-size vertical sheets, only the number-of-sheets counter C1 increases its count for the initial 42 sheets, and the number-of-sheets counter C1 and the temperature-rise counter C2 increase their counts for the remaining 8 sheets. When the count of the number-of-sheets counter C1 reaches 150,000, the count of the temperature-rise counter C2 increased by only 10 hours with respect to 45 hours corresponding to the end of the lifespan. When a notification of the end of the lifespan was provided, the tube of the pressing roller 45 was hardly wrinkled, and there were no issues present when the feeding of A3-size sheets was checked.

In the comparative example, under all of the above-described sheet feeding conditions, the number-of-sheets counter C1 indicated that sheet feeding was possible for up to 150,000 sheets corresponding to the end of the lifespan. In the pressing roller 45 after a notification of the end of a lifespan, while almost no wrinkling occurred in the tube under sheet feeding conditions 1 and 4, serious wrinkling occurred under sheet feeding conditions 2 and 3.

For each sheet feeding of 10,000 sheets and in the sheet feeding of A3-size sheets after a notification of the end of the lifespan, it was confirmed that there were no issues present under conditions 1 and 4. It was confirmed that wrinkling occurred at a feeding of a 50,000th sheet and subsequent sheets under sheet feeding condition 2 and at a feeding of a 110,000th sheet and subsequent sheets under sheet feeding condition 3. This is because, under sheet feeding conditions 2 and 3, the sheet feedings were repeated for a long time in a state in which the temperature rise of the sheet non-passing portion of the pressing roller 45 exceeded 200° C.

In the state in which the temperature of the sheet non-passing portion of the pressing roller 45 exceeds 200° C., the thermal expansion amount of rubber increases. When this continues for a long time, the tube that is spread by the thermal expansion of the rubber is plastically deformed. When the expanded tube is plastically deformed, in a state in which the temperature of the sheet non-passing portion of the pressing roller 45 does not rise, the tube slackens. This results in the tube wrinkling. When the tube is wrinkled, a conveying force at end portions is decreased. This results in when A3-size sheets are fed, rear-edge sides of the sheets being unstably conveyed and the sheets being wrinkled.

As described above, by counting the time during which the temperature rise of the sheet non-passing portion is in the state exceeding 200° C. and by controlling this as the end of the lifespan, it is possible to notify the user that the end of the lifespan is reached before a sheet is wrinkled due to wrinkling of the tube. Even if a user frequently uses small-sized sheets, when the sheets are fed such that the temperature rise of the sheet non-passing portion scarcely exceeds 200° C., the count of the temperature-rise counter C2 scarcely increases and the end of the lifespan is determined at the number-of-sheets counter C1. This results in the number of sheets that can be fed not decreasing.

While, in the present embodiment, the threshold temperature is set at 200° C. and the end of the lifespan at the temperature-rise counter C2 is set at 45 hours, since the probability of occurrence of issues differs depending upon the fixing device or the image forming apparatus, the threshold temperature and the end of the lifespan may be changed.

A plurality of values may be set for the threshold value. The addition amount per one unit hour in a state in which a higher threshold temperature is exceeded may be increased.

### Second Embodiment

The above-described first embodiment provides an example in which the temperature detecting sensor 47 is provided at an end portion of the pressing roller 45 and the temperature rise of the sheet non-passing portion is directly measured to control the thermal history of the sheet non-passing portion of the pressing roller 45. A second embodiment that differs from the first embodiment in that the thermal history of a sheet non-passing portion of a pressing roller 45 is controlled without directly measuring the temperature of the sheet non-passing portion of the pressing roller 45 will now be described.

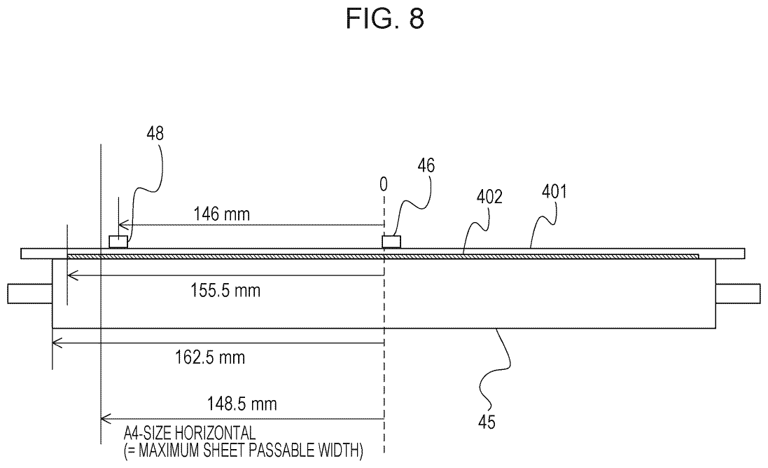

FIG. 8 is a schematic view of a fixing device 40 according to the second embodiment. A recording medium P with a maximum width that can be passed is an A4-size horizontal sheet (297 mm), where half of this width is 148.5 mm. In order to ensure the fixing ability at an end portion of a resistive heating element 402, the length of the resistive heating element 402 is set at 155.5 mm from a conveyance reference O of a recording medium P (the total length is 311 mm). Since an end portion of the pressing roller 45 needs to cover the resistive heating element 402, the end portion is set at a position that is 162.5 mm from the conveyance reference O of the recording medium P.

In the present embodiment, an end-portion thermistor 48 for measuring the temperature of a back surface of an end portion of a heater is disposed at a position that is 146 mm from the conveyance reference O of the recording medium P. The end-portion thermistor 48 enables monitoring the state of temperature rise of the sheet non-passing portion. While, in the present embodiment, the end-portion thermistor 48 is provided, in a longitudinal direction of the heater, on only one of two sides from the conveyance reference O of the recording medium P, two end-portion thermistors may be provided on the two sides.

Since the relationship between the temperature of the sheet non-passing portion of the pressing roller 45 and the temperature that is detected at the end-portion thermistor 48 changes for each sheet size, a threshold temperature is set for each sheet size. By counting the time when a temperature becomes greater than or equal to the threshold value, or by counting the number of fed sheets, it is possible to provide a notification of the end of the lifespan of the fixing device 40.

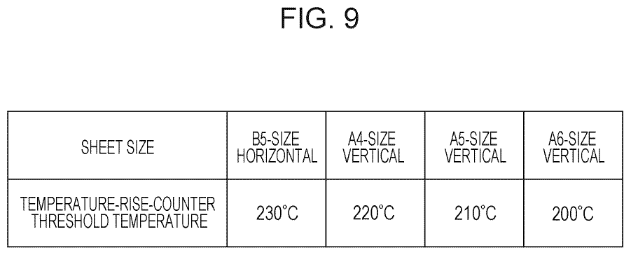

FIG. 9 illustrates the threshold temperature of the end-portion thermistor 48 for each sheet size. The threshold temperature is set at a temperature that the end-portion thermistor 48 detects when the temperature rise of the sheet non-passing portion of the pressing roller 45 becomes substantially 200° C.

In the present embodiment, to suppress thermal expansion of a rubber layer 45R caused by the temperature rise of the sheet non-passing portion of the pressing roller 45, when the detection temperature of the end-portion thermistor 48 reaches the threshold temperature, control to increase a conveyance interval of recording media at the time of continuous printing is executed. This control enables slowing down the rising speed of temperature rise of the sheet non-passing portion.

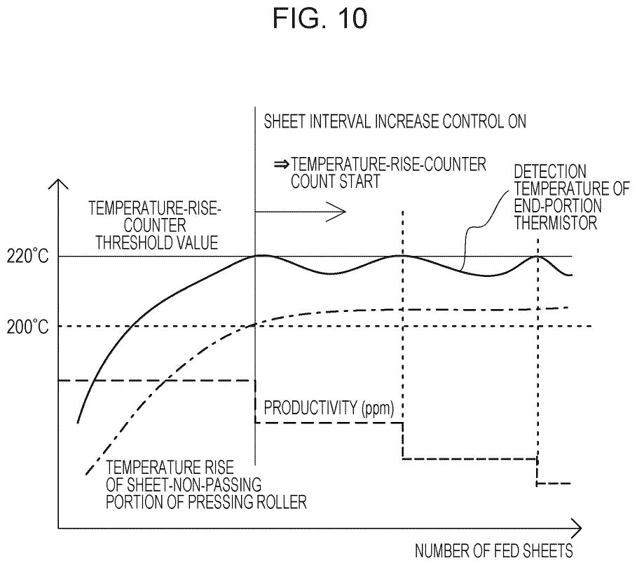

FIG. 10 is a view illustrating sheet interval increase control and a count start timing of a temperature-rise counter C2 of the present embodiment. In FIG. 10, the horizontal axis indicates the number of fed sheets and the vertical axis indicates the temperature and the productivity. When A4-size vertical recording media P with a width that is smaller than a maximum sheet width that can be passed are continuously fed, the temperature rise of the sheet non-passing portion of the pressing roller 45 and the detection temperature of the end-portion thermistor 48 disposed on the back of the heater increase.

When the detection temperature of the end-portion thermistor 48 reaches 220° C. that is the threshold temperature, the temperature rise of the sheet non-passing portion of the pressing roller 45 is near 200° C. At a timing in which the detection temperature of the end-portion thermistor 48 exceeds the temperature threshold value, the sheet interval increase control is performed and the addition of a count at the temperature-rise counter C2 is started.

Since the productivity is decreased due to the increase in the sheet interval, the detection temperature of the end-portion thermistor 48 is temporarily decreased. By continuing feeding sheets, the detection temperature reaches the threshold temperature again. By performing the sheet interval increase control at this timing, the sheet interval is increased and thus the productivity is decreased. This provides for temporarily decreasing the detection temperature of the end-portion thermistor 48.

By increasing the sheet interval by performing the sheet interval increase control each time the detection temperature of the end-portion thermistor 48 exceeds the threshold temperature, the detection temperature of the end-portion thermistor 48 can be controlled to a detection temperature that is substantially less than or equal to the threshold temperature. Since it is possible to slow down the increase of the temperature rise of the sheet non-passing portion of the pressing roller 45 and to delay serious wrinkling of the tube, the lifespan of the fixing device 40 can be increased.

While the temperature-rise counter C2 of the first embodiment counts the time during which the temperature is greater than or equal to the threshold temperature, the number of fed sheets during which the temperature is greater than or equal to the threshold temperature may be counted.

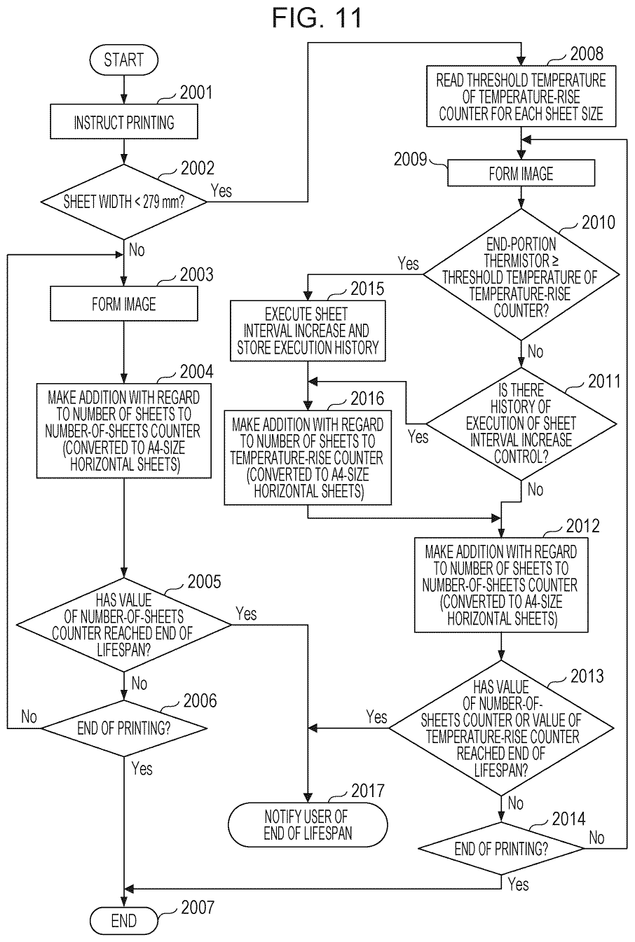

FIG. 11 is a flowchart regarding notification of the end of the lifespan when printing is performed.

When a user provides a printing instruction (2001), it is determined whether a sheet width is less than 279 mm from print information (2002). When the sheet width is greater than or equal to 279 mm, an addition with regard to the number of sheets converted to A4-size horizontal sheets is made to the number-of-sheets counter C1 from sheet size information for each image formation (2003, 2004).

Next, when the number of sheets of the number-of-sheets counter C1 has reached 150,000 (2005), the printing is suspended and a notification is provided to the user that the end of the lifespan of the fixing device 40 has been reached (2017). When the number of sheets of the number-of-sheets counter C1 has not reached 150,000 (2005), a determination is made whether printing has ended (2006). If it is determined that printing has not ended, then 2003 to 2006 are repeated until the printing ends. If it is determined that printing has ended (2006), the flowchart of FIG. 11 ends (2007).

When the sheet width is less than 279 mm from the sheet size information of a print signal (2002), the threshold temperature that is set for each sheet size written to ROM 72 is read (2008). Image formation is started (2009), and a comparison is made whether the detection temperature of the end-portion thermistor 48 is greater than or equal to the threshold temperature (2010).

When the detection temperature of the end-portion thermistor 48 is less than the threshold temperature, it is determined whether a history of an execution of sheet interval increase control from the start of the image formation is stored in RAM 73 (2011). When there is no history of an execution of sheet interval increase control, an addition with regard to the number of sheets converted to A4-size horizontal sheets is made to the number-of-sheets counter C1 from the sheet size information (2012).

It is then determined whether the value of the number-of-sheets counter C1 has reached the end of the lifespan (2013). When the end of the lifespan has been reached, a notification is provided to the user that the end of the lifespan has been reached (2017). When the end of the lifespan has not been reached, it is determined whether to end the printing (2014). When it is determined to end the printing, the flowchart of FIG. 11 ends (2007). When it is determined not to end the printing, the flow returns to 2009.

When the detection temperature of the end-portion thermistor 48 exceeds the threshold temperature (2010), based on a program of sheet interval increase control stored in the ROM 72, the CPU 71 changes a timing of driving a sheet feeding roller 13. Since a feeding interval is increased, the control of increasing the sheet interval is executed and the history of the execution of the sheet interval increase control is stored in the RAM 73 (2015). After the execution of the sheet interval increase control, an addition with regard to the number of sheets converted to A4-size horizontal sheets is made to the temperature-rise counter C2 and the number-of-sheets counter C1 (2016, 2012).

When the detection temperature of the end-portion thermistor 48 is less than the threshold temperature (2010), and the history of the execution of sheet interval increase control is stored in the RAM 73 (2011), the temperature of the end-portion thermistor 48 exceeds the threshold temperature of the temperature-rise counter C2 once. Therefore, an addition with regard to the number of sheets converted to A4-size horizontal sheets is made to the temperature-rise counter C2 and the number-of-sheets counter C1 (2016, 2012). Thereafter, when the value of the number-of-sheets counter C1 or the value of the temperature-rise counter C2 has reached the end of the lifespan, a notification is provided to the user that the end of the lifespan has been reached (2017).

While, in the second embodiment, the threshold temperature and the temperature threshold value at which the sheet interval increase control is executed are the same, the threshold temperatures may be set to be different temperatures. When they are set to be the same, the temperature-rise counter C2 only counts the number of fed sheets in a state in which the sheet interval increase control is executed, which simplifies control.

While an example in which, in order to suppress occurrence of wrinkling of the tube of the pressing roller 45, sheet interval increase control is executed at the timing in which the detection temperature of the end-portion thermistor 48 reaches the threshold temperature has been described, the sheet interval increase control need not be executed when productivity is considered important.

In the first and second embodiments, the number-of-sheets counter C1 that controls the end of the lifespan of the fixing film 41 is used as a lifespan counter different from the temperature-rise counter C2. In another embodiment, a counter that controls the end of the lifespan of something other than the fixing film 41 can be used as a lifespan counter different from the temperature-rise counter C2.

While, in the first and second embodiments, control of the end of the lifespan of a film-heating fixing device has been described, the lifespan control method in the first or second embodiments may be applied to control of the end of the lifespan of a fixing device not including a fixing film 41.

While the present disclosure has been described with reference to the above-described embodiments, it is to be understood that the present disclosure is not limited to these embodiments. The scope of the following claims is to be accorded the broadest interpretation so as to encompass all such modifications and equivalent structures and functions.

This application claims the benefit of Japanese Patent Application No. 2024-166046, filed Sep. 25, 2024, which is hereby incorporated by reference herein in its entirety.

What is claimed is:

1. An image forming apparatus comprising:
an image forming unit that forms an image on a recording medium;
a fixing unit that fixes the image to the recording medium on which the image is formed while the recording medium is nipped and conveyed at a fixing nip portion, the fixing unit including a fixing rotating body and a pressing roller that contacts an outer peripheral surface of the fixing rotating body and forms the fixing nip portion between the pressing roller and the fixing rotating body, the pressing roller including a rubber layer and a fluororesin surface tube layer;
at least one memory storing a program;
at least one processor, that when executing the program, is caused to determine an end of a lifespan of the fixing unit and provide notification to replace the fixing unit based on a result of the determination;
a temperature-rise counter that increases a count when a temperature of a sheet non-passing portion of the pressing roller exceeds a threshold temperature, the temperature of the sheet non-passing portion being a temperature when an image is formed on a recording medium with a width in an axial direction of the pressing roller that is smaller than a maximum width that is usable in the image forming apparatus; and
a lifespan counter different from the temperature-rise counter,
wherein determining the end of the lifespan of the fixing unit is based on a count value that increases the most between a count value of the temperature-rise counter and a count value of the lifespan counter different from the temperature-rise counter.

2. The image forming apparatus according to claim 1,
wherein when an image is formed on a recording medium with the maximum width the count value of the temperature-rise counter does not increase.

3. The image forming apparatus according to claim 1,
wherein the temperature-rise counter counts a time or a number of fed sheets.

4. The image forming apparatus according to claim 1, wherein the fixing unit includes a temperature detecting sensor that detects the temperature of the sheet non-passing portion of the pressing roller, and wherein the temperature-rise counter increases the count when a detection temperature detected by the temperature detecting sensor exceeds the threshold temperature.

5. The image forming apparatus according to claim 1, wherein the fixing unit includes a heater that heats the fixing rotating body and a temperature detection element that corresponds to the sheet non-passing portion of the pressing roller and that detects a temperature of the heater, and wherein the temperature-rise counter increases the count when a detection temperature detected by the temperature detection element exceeds the threshold temperature.

6. The image forming apparatus according to claim 1,
wherein the fixing rotating body is a fixing film,
wherein the fixing unit includes a heater that is disposed in an internal space of the fixing film, and
wherein the fixing nip portion is formed by the heater and the pressing roller with the fixing film interposed between the heater and the pressing roller.
